(19) United States
(12) Patent Application Publication
(10) Pub. No.: US 2007/0053020 A1
(43) Pub. Date: Mar. 8, 2007

(54) SHEET PROCESSING APPARATUS FOR IMAGE FORMING AND BINDING

(75) Inventors: Masayoshi Kubo, Kashiwa-shi (JP); Koji Minobe, Abiko-shi (JP)

Correspondence Address: FITZPATRICK CELLA HARPER & SCINTO, 30 ROCKEFELLER PLAZA, NEW YORK, NY, 10112, US

(73) Assignee: CANON FINETECH INC., Joso-shi (JP)

(21) Appl. No.: 11/469,678

(22) Filed: Sep. 1, 2006

(30) Foreign Application Priority Data
Sep. 6, 2005 (JP) 2005-258369

(51) Int. Cl. H04N 1/04

(52) U.S. Cl. 358/498

(57) ABSTRACT

A sheet processing apparatus includes: a loading portion which loads sheets where images of image data are formed, the sheets in a standard size larger than a designated finish size on the image data; a binding portion which binds a stacked sheet stack; a cutting portion which cuts the bound sheet stack; and a control portion which controls the cutting portion so that the bound sheet stack in the standard size is cut in a finish size based on finish size information of the above described image data.

### BACKGROUND OF THE INVENTION

1. Field of the Invention

The present invention relates to a sheet processing apparatus which stacks sheets delivered from an image forming apparatus, for example, into a stacked state to stitch them with adhesive glue and the like and thereafter cuts a predetermined portion of sheet periphery borders.

2. Description of the Related Art

In general, there known widely is a post-processing apparatus which prints an image produced by a computer, a word processor and the like with a printer apparatus to align a series of sheets after that printing to implement stapler stitching, adhesive stitch binding and the like. In addition, recently an image forming system of outputting booklets for respective kinds of business at every occurrence of need is advanced to realize utilization as on-demand printing. In such a system, there needed is a binding apparatus that glues an end border (back) of a series of documents sequentially delivered from a printer and automatically implements binding by bending that glued face in coordination with the cover sheet center and in that case there provided is a binding apparatus to cut a predetermined portion of periphery borders except the stitched back to cut and align into a booklet state.

Conventionally, this type of binding apparatus is disposed as a post-processing apparatus of an image forming apparatus as disclosed, for example, in FIG. 1 of Japanese Patent Application Laid-Open No. 2004-114196 to proceed with binding by receiving printed sheets from the image forming apparatus, stacking them into a stacked state and spreading adhesive glue. And there known as control thereof is respectively a configuration of implementing contra as a slayer apparatus and a configuration of implementing control independently as a standalone apparatus based on signals in receipt from an image forming apparatus. For any of those apparatus configurations, in the case where a binding mode is selected, there implemented is a finishing processing of binding sheets together into a booklet state and thereafter cutting a predetermined amount of sheet periphery borders to cut and align sheet end faces. In that case, a conventionally known apparatus cuts and aligns the back portion adhered with adhesive glue and the end portion being an opposite end face and therefore such an event is known that an image forming apparatus, for example, gets worse in appearance since the end portion gets shorter in case of proceeding with image printing in the A4 size in the JIS standards.

### SUMMARY OF THE INVENTION

As described above, the conventional binding apparatus is configured to establish an apparatus of cutting a preset predetermined amount of a sheet stack subject to adhesive stitch binding. Therefore, cutting sheet periphery borders or a head portion, a tail portion and an end portion, for example, respectively will lead to finishing as a booklet different from a standardized size with periphery border room space in the printing area being different from normal ones. In addition, depending on apparatus configuration, it is also comprehensible that a user selects the size of a sheet to be printed to designate a cutting size (cutting width) of the sheet periphery borders. However, since a normal image processing apparatus automatically recognizes the size of a sheet (image data) to become manuscript or of the size of a print sheet in that case, a general user who is unskilled in an apparatus system such as releasing that will be made unable to avoid a complicated setting. In addition, disposition of a binding apparatus as a sheet processing apparatus used to give rise to a problem of making operability very bad.

In order to solve the above described problems, a sheet processing apparatus of the present invention comprises the following: a stacking portion configured to load sheets where images of image data are formed, the sheets in a standard size larger than a designated finish size on the image data; a binding portion configured to bind a stacked sheet stack; a cutting portion configured to cut the bound sheet stack; and a control portion configured to control the cutting portion so that the bound sheet stack in the standard size is cut in a finish size based on finish size information of the above described image data.

Moreover, the sheet processing apparatus further comprising: a sheet feed portion configured to retain the sheets in a plurality of standard sizes; a sheet select portion configured to select the sheets in a standard size larger than a sheet in the above described finish size from the sheet feed portion; and an image forming portion configured to form images onto a sheet in a selected standard size.

In addition, the above described sheet select portion selects a sheet in the smallest standard size among the sheets in standard sizes larger than the finish size of the above described image data.

Moreover, the sheet processing apparatus comprises a transport portion of transporting a sheet stack to a cutting position of the above described cutting portion, wherein the above described control portion determines a transport amount of the above described transport portion according to a finish size to, thereby, control a position of the sheet stack toward the above described cutting position.

In the present invention, the image forming apparatus is designed, at the time of forming images, to select, based on a sheet size of image data or a designated final finish size (standard size), a print sheet in a size larger than this size and form a surplus margin in its periphery borders to form images, and on the other hand, the binding apparatus is designed to operate a cutting amount of a sheet based on standard size information and print sheet size information in the above described image forming apparatus to cut them. Therefore, a final sheet stack having undergone binding and aligned cutting in the periphery borders is finished up in a fixed size or a designated finish size. Accordingly, binding in a fixed size and abundant in beauty in appearance is feasible compared with binding in an unnatural size of implementing print on sheets in a conventional fixed size to align and cut them in their periphery borders.

In particular, binding and finishing in a desired size such as conventional fixed size and the like used to require skills for selecting print sheets, setting image forming areas to this selected sheet, setting of cutting amount in the periphery borders and the like, and in case of an image forming apparatuses being a normal apparatus of recognizing sheet sizes and automatically implementing printing, cumbersome work such as releasing its functions and the like used to become unavoidable. The present invention enables binding in a desired finish size with a simple operation without requiring such training and complicated work.

Moreover, selection of a sheet in the smallest size larger than a standard size at the time of selecting a print sheet will make it possible to limit the cutting amount to cut by the binding apparatus to a small amount to make processing of the cutting waste easier. In addition, setting sheets prepared in the image forming apparatus will require neither inconvenience of supplying print sheets nor preparation of sheets in special sizes. That is, the present invention will give rise to an effect that a desired binding finish is feasible with simple operations.

Further features of the present invention will become apparent from the following description of exemplary embodiments with reference to the attached drawings.

### BRIEF DESCRIPTION OF THE DRAWINGS

FIG. 1 is a schematic configuration diagram of a sheet processing apparatus related to an embodiment of the present invention.

FIG. 2 is an explanatory diagram of a sheet flow from image forming to binding of the apparatus in FIG. 1 (first method).

FIG. 3 is an explanatory diagram of a sheet flow from image forming to binding of the apparatus in FIG. 1 (first method).

FIG. 4 is an explanatory diagram of a sheet flow from image forming to binding of the apparatus different from that in FIG. 2.

FIG. 5 is a schematic configuration diagram of a cutting portion of the binding apparatus configuring the sheet processing apparatus in FIG. 1.

FIG. 6 is a plan view of the cutting portion in FIG. 5.

FIG. 7A shows a state in operation of a cutting border press means in the apparatus in FIG. 5, being a retreat state with a holding member having retreated from the sheet.

FIG. 7B shows a state in operation of a cutting border press means in the apparatus in FIG. 5, being a state in operation where a holding member presses the sheet.

FIG. 8A is a perspective view of cutting a head portion in the sheet cutting procedure in the apparatus in FIG. 5.

FIG. 8B is a perspective view of cutting a tail portion in the sheet cutting procedure in the apparatus in FIG. 5.

FIG. 8C is a perspective view in a state of cutting an end portion in the sheet cutting procedure in the apparatus in FIG. 5.

FIG. 9A shows a state of a home position of a cutter blade in the apparatus in FIG. 5.

FIG. 9B shows a state of a cutting position of a cutter blade in the apparatus in FIG. 5.

FIG. 9C shows a state of a cutting position of a cutter blade in the apparatus in FIG. 5.

FIG. 10 is a block diagram showing control of the sheet processing apparatus in FIG. 1.

FIG. 11 is a flow chart showing a procedure of cutting sheets with the apparatus in FIG. 4.

FIG. 12 is an explanatory table showing selection of print sheets in the sheet processing apparatus in FIG. 1.

### DESCRIPTION OF THE EMBODIMENTS

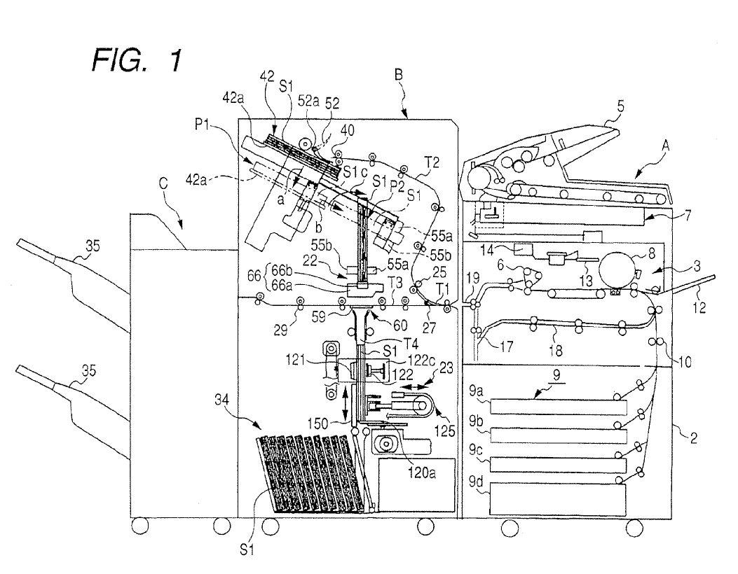

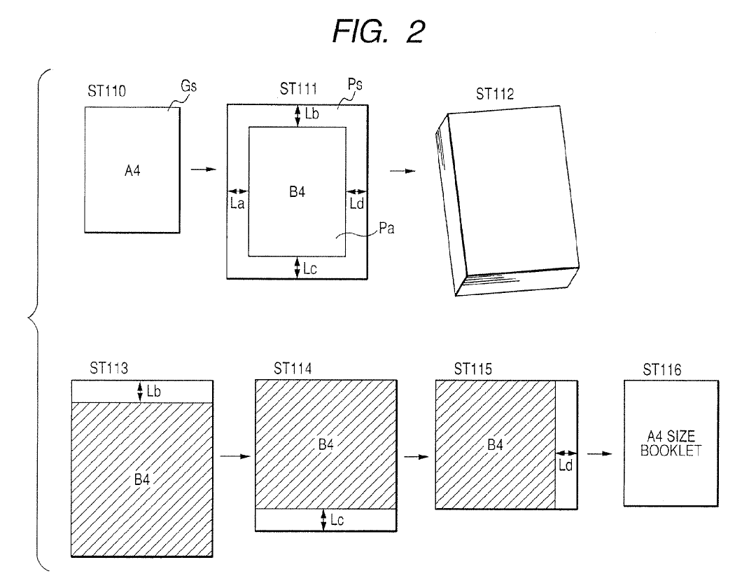

The present invention will be described in detail based on depicted embodiments. FIG. 1 is an entire configuration diagram of a sheet processing apparatus comprising a sheet cutting apparatus related to the present invention incorporated therein while FIG. 2 to FIG. 4 are explanatory diagrams showing an image forming method thereof and a sheet periphery border cutting method thereof.

At first, a principle of the present invention will be described on a sheet processing apparatus shown in FIG. 1 to FIG. 4. There present are a case where the sheet processing apparatus of the present invention is configured, as a so-called network printing system, by an image forming apparatus A connected to an external apparatus such as a computer and a binding apparatus B connected to this image forming apparatus A and a case where the sheet processing apparatus of the present invention is configured, as a photocopy printing system, by an image forming apparatus A such as a photocopier and a binding apparatus B connected thereto. Any system comprises an image forming apparatus A of printing image data onto a sheet and a binding apparatus B of stacking the already printed sheets thereof in the order of page to bind them into a stacked state and to subsequently cut a predetermined amount of periphery borders thereof and align them in order.

And the external apparatus (a computer apparatus and the like), the image forming apparatus A or the binding apparatus B comprises mode select means. This mode select means is incorporated into driver software of a computer and the like in case of an external apparatus, and is configured so as to be operated with input means such as a keyboard, and is configured, in case of a photocopy printing system, by input means such as an image forming apparatus A or a control panel and input buttons provided in a binding apparatus B. And this mode select means has a cut and bind mode of binding printed sheets in a stacked state to cut the periphery borders and this cut and bind mode comprises input means of designating binding modes of right-side binding or left-side binding of the printed sheets.

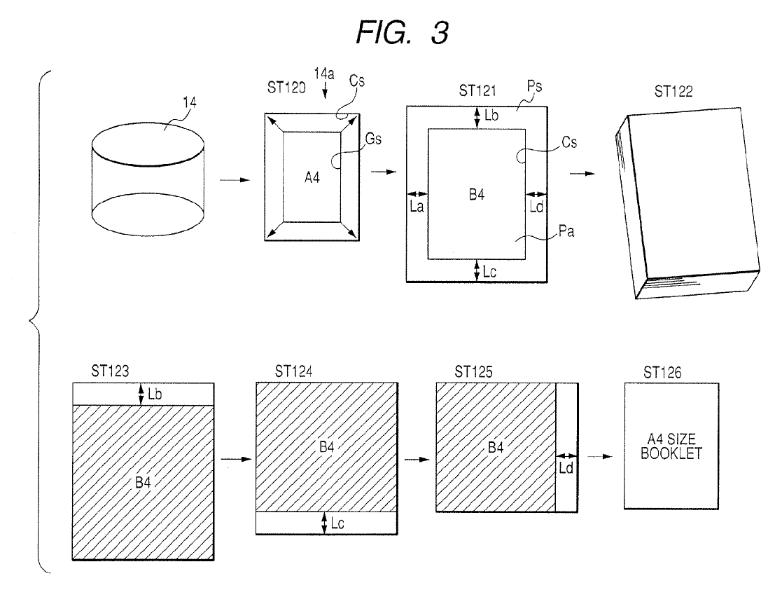

In such a configuration, when the cut and bind mode is selected, the image forming apparatus A carries out a first or a second image forming operation. The first method is a method of forming images based on sheet size information for image data retained in the image forming apparatus A as shown in FIG. 2 or transferred from an external apparatus while the second method is a method of forming images based on finish sheet size information inputted and designated with the above described mode select means as shown in FIG. 3.

In the first method, the image forming apparatus A automatically selects, based on a sheet size Gs for image data, sheet size Ps for a print shoot from sheet feed means (sheet feed cassette to be described below) larger than this sheet size Gs for image data (ST110). Selection of this print sheet is carried out with any of methods (1) to (4) described below. And the image forming portion 3 of the image forming apparatus A implements printing at a predetermined position of the selected print sheet. For example, when A4 is selected as the sheet size Gs for image data, left binding is selected as the above described mode select means and B4 is selected as sheet size Ps for the print sheet with a method to be described later, a print area Pa is set as follows onto the print sheet. At first, a binding margin La set in advance is formed at the left end of the print sheet and then the margin Lb of a head portion and the margin Lc of a tail portion Lc of the sheet undergo calculation (Lb=Lc=(B4 size length−A4 size length)/2), that is, sheet size length of the image data is subtracted from size length of the print sheet and then the result is divided by two. Such a margin is formed and A4 size image is printed inside the print sheet (ST111). For allocation of this print area, a binding margin La is formed by offsetting, for example, at the time when a latent image is formed in a photosensitive drum, then the sheet protrudes so that the head portion margin Lb is formed at the time when this latent image is coated with toner and thereafter is transferred to the print sheet to as to form the head portion margin Lb.

The sheet printed thus with the image forming apparatus A is sequentially loaded in a stacked state with below described stack means in the binding apparatus B so that the left end (back) of this sheet stack is bound together by below described sheet stack bind means (ST112). And this bound sheet stack is transported to a cutting position by a cutting sheet transport means for carrying out transport to a predetermined position. This cutting sheet transport means is configured to carry out rotation of the sheet stack and transport to the cutting position with a rotary table to be described below, for example, and a gripper of gripping and pressing sheets to this rotary table to rotate the sheet stack and transport it to a cutting position and control means of the drive motor thereof comprises an operation means of operating the cutting amount of the sheet based on the sheet size Gs for image data and the sheet size Ps for the print sheet. The operation means hereof calculate the above described head portion margin Lb (ST113), tail portion margin Lc (ST114) and end portion margin Ld (by subtracting the binding margin La from the size length of the print sheet) (ST115). And based on that operation result, the sheet stack is controlled on the transport amount for transport to the cutting position. The sheet stack S1 set thus for transport at the cutting position is sequentially cut by the cutting means. Thereby, based on the sheet size Gs for image data a print sheet larger than this undergoes printing so that a series of sheets are bound together in a stack state and thereafter surplus margin at the head portion, the tail portion and the end portion thereof are cut respectively so that binding finish (ST116) is implemented in such a size that corresponds with the sheet size Gs for image data.

Next, the second method is a case where image forming is carried out based on the finish sheet size Cs inputted and designated with the above described mode select means as shown in FIG. 3, so that the image data is enlarged or downscaled to undergo development to print data (ST120) with a data processing portion 14a of developing image data from the data storing portion 14 based on the finish sheet size Cs. Concurrently, the image forming apparatus A automatically selects a print sheet larger than this finish size from sheet feed means. Selection of this print sheet is carried out with any of methods (1) to (4) described below. And the image forming portion 3 of the image forming apparatus A implements printing at a predetermined position of the selected print sheet. For example, when A5 is selected as the sheet size for image data, A4 is selected as the final finish sheet size Cs, left binding is selected as the above described mode select means and B4 is selected as sheet size for the print sheet with a method described later, the data processing portion 14a enlarges the image data from the A5 size to the A4 size to cause it to correspond with the finish print size Cs (ST120).

And the print area Pa is set onto the print sheet likewise the above described case. Subsequently, likewise described above, printing is implemented (ST121), the sheets are loaded in a stack state with the binding apparatus B so that the left end (back) of the sheet stack is bound together (S122). And this bound sheet stack S1 is transported to a cutting position with a cutting sheet transport means so that the sheet cutting amount is operated based on the finish sheet size Cs and the sheet size Ps of the print sheet. This operation is implemented by calculating the above described head portion margin Lb (ST123), tail portion margin Lc (ST124) and margin of end portion Ld (by subtracting the binding margin La from the size length of the print sheet) (ST125). And based on that operation result, the sheet stack S1 is controlled on the transport amount for transport to the cutting position to undergo cutting. Thereby, based on the finish sheet size Cs designated with the mode select means, a print sheet larger than this undergoes printing. Then, a series of sheets are bound together in a stack state and thereafter surplus margins at the head portion, the tail portion and the end portion thereof are cut respectively so that binding finish (ST126) is implemented in such a size that corresponds with the designated finish sheet size Cs.

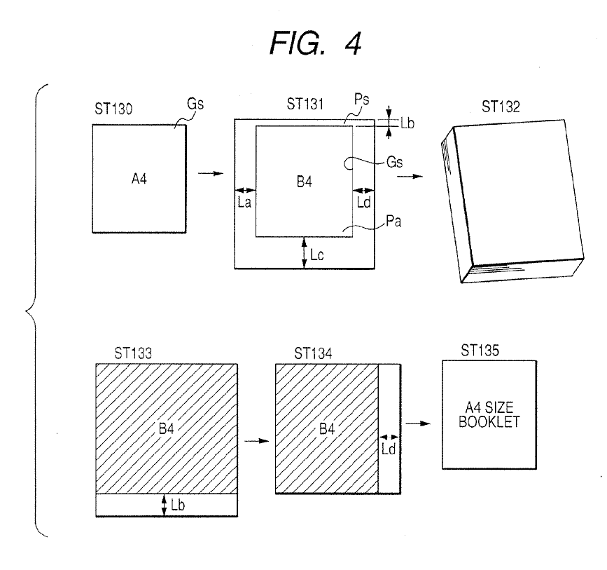

Next, since three portions of the head portion, the tail portion and the end portion in exception of the back portion where the above described sheets have been bound together undergo cutting, it takes time to proceed with cutting. FIG. 4 shows processing in case of taking two portions of the smallest limit as the portions for cutting. This will be described with respect to the above described first method. As described in FIG. 2, the sheet size Ps for the print sheet is selected automatically based on the sheet size Gs for the image data (ST131). And the image forming portion 3 of the image forming apparatus A carries out printing in a predetermined position of the selected print sheet. However, at that time, for example, when A4 is selected as the sheet size Gs for image data, left binding is selected as the above described mode select means and B4 is selected as sheet size Ps for the print sheet with a method to be described later, a print area Pa is set as follows onto the print sheet.

At first, a binding margin La set in advance is formed at the left end of the print sheet and likewise a margin Lb set in advance is formed at the head portion of the sheet. There, the tail portion margin Lc undergoes subtraction Lc=(B4 size length−A4 size length), that is, sheet size length of the image data is subtracted from print sheet size length to form the margin. Next, the margin Ld of the end portion is likewise set to Ld=(B4 size length−A4 size length). Forming such margins, an A4 size image undergoes printing inside a print sheet (ST111). For allocation of this print area, a binding margin La is formed by offsetting, for example, at the time when a latent image is formed in a photosensitive drum, then the sheet protrudes so that the head portion margin Lb is formed at the time when this latent image is coated with toner and thereafter is transferred to the print sheet so as to form the head portion margin Lb.

On the other hard, in the binding apparatus B, the left end (back) of the sheet stack is bound together by sheet stack stitch means (ST132). Next, likewise described above, the cutting amount of the sheet is operated. At that time, the operation means calculates the above described tail portion margin Lc (ST114), end portion margin Ld respectively (by subtracting the head portion margin or the binding portion margin La from the print sheet size length) (ST133). And based on that operation result, the sheet stack is controlled on the transport amount for transport to the cutting position. The sheet stack S1 set thus for transport at the cutting position is cut sequentially from the tail portion (ST133) to the end portion (ST134) by the cutting means. Thereby only executing sheet cutting at two places by cutting means, binding finish (ST135) is implemented in size corresponding with a predetermined sheet size Gs for image data.

As described above, in order for the image forming apparatus A to select a print sheet with the first and the second method, any of the following methods are adopted. In general, sheet sizes which users take for general purposes are set to an image forming apparatus A. A user selects to use sheets of this standard size, and houses sheets in different sizes in a plurality of sheet feed cassettes as will be described below so as to select sheets from those cassettes and use them. Here, (1) any of sheets in standardized sizes such as JIS standards A series sizes, JIS standards B series sizes, inch sizes or the like larger than the above described sheet size Gs for image data or final finish sheet size Cs are selected. In that case, with presence of a plurality of sheets in the adopted size, the smallest sheet among the adopted sizes is selected; the largest sheet is always selected; or the sheet with the largest sheet remaining amount is selected. With no presence of sheets in the adopted size in the sheet feed cassette, a warning is set to be generated to urge supply of sheets.

(2) Sheets in the smallest size among sheets in standardized sizes such as a JIS standards A series sizes, JIS standards B series sizes, inch sizes or the like larger than the above described sheet size Gs for image data or final finish sheet size Cs are selected on a priority basis. In this case, with no presence of sheets in the adopted size in the sheet feed cassette, a warning is set to be generated to urge supply of sheets. (3) Sheets in the smallest size, that are retained in the sheet feed cassette, among sheets in standardized sizes such as JIS standards A series sizes, JIS standards B series sizes, inch sizes or the like larger than the above described sheet size Gs for image data or final finish sheet size Cs are selected on a priority basis. In the case where no sheet in B4 size is present in the cassette with the sheet size being A4 size for example, sheets in A3 size are selected. (4) Sheets in the smallest size retained by the above described print means among sizes larger than the above described sheet size Gs for image data or the final finish sheet size Cs are selected.

“Configuration of Image Forming Apparatus”

A sheet processing apparatus shown in FIG. 1 is configured by an image forming apparatus (photocopier is shown in the drawing) A; a binding apparatus (binding portion) B connected to sheet delivery port of this image forming apparatus; and a post-processing apparatus (post-processing portion) C that is disposed at a downstream side of sheet transport of that binding apparatus B. A sheet cutting unit related to the present invention is incorporated in the binding apparatus D. The image forming apparatus A, the binding apparatus B and the post-processing apparatus C shown in the drawing are respectively configured as apparatus usable alone. The binding apparatus B receives a series of documents from a delivery port of the image forming apparatus A, stacks them in a stacked state, applies adhesive to a side border thereof to bind it together with a cover sheet to form it in a booklet state, next cuts the sheets in this booklet state at the periphery borders that do not undergo adhesive applying by a predetermined amount and stacks it into a storing stacker. In addition, the post-processing apparatus C is annexed to the binding apparatus B and is configured, in receipt of sheets that have not yet undergone bind processing, to implement post-processing such as staple binding, punching (punch processing), stamping (stamp processing) and the like. In addition the post-processing apparatus C shown in the drawing comprises a function as a delivery stacker of storing sheets that have undergone image forming with the image forming apparatus A. Those respective apparatuses will be described below.

“Configuration of Image Forming Apparatus”

As shown in FIG. 1, a photocopier A as an image forming apparatus is configured by an image forming portion 3 disposed inside the main apparatus 2; an image scanning apparatus (scanner unit) 7 disposed in the upper portion of this main apparatus 2; and an automatic document feeder (ADF unit) 5. The main apparatus 2 is provided with an image forming portion 3. This image forming portion 3 forms images onto sheets such as plain sheets, OHP sheets and the like. An electrostatic printing system is adopted for the image forming portion 3 shown in the drawing which is provided with a photosensitive drum 8 and light irradiation means 13 of forming electrostatic latent images onto this drum 8. Around the photosensitive drum 8 such as OPC, selenium and the like, the light irradiation means 13, a developing device and a transferring charger are disposed. And the image data sent from an image scanning apparatus 7 to be described later are stored in a data storing portion 14. Receiving the data from this data storing portion 14 sequentially, the light irradiation means 13 such as a laser emitting element and the like forms a latent image onto the surface of the photosensitive drum 8 and attach toner to this latent image with the developing device.

On the other hand, a plurality of cassettes in different sizes are respectively disposed in a sheet feed portions 9 in the main apparatus 2 and a predetermined sheets selected from these cassettes are guided to the photosensitive drum 8 with the transport roller 10. And the toner on the drum 8 is transferred onto this sheet with a charger not shown in the drawing and undergoes heat fixing with a fixing device 6. The sheet thus having undergone image forming is delivered to the delivery port from the sheet delivery path 19. At the same time, the sheet delivery path 19 is provided with a switch back path 17 of reversing the front and back of the sheet. In the both side printing mode of forming images onto the two sides of a sheet, the sheet is transported from the fixing device 6 to the switch back path 17 and is transported to the entrance of the photosensitive drum 8 again in a front-back reversed state from a circulating path 18. And a sheet having undergone printing on one side undergoes printing on its reverse side and is guided to the sheet delivery path 19 through the fixing device 6. Here, reference numeral 12 shown in the drawing denotes a manual sheet feed port to supply, for example, thick sheets such as cover sheets and special sheets such as coating sheets.

An image scanning apparatus (scanner unit) 7 is disposed in the upper portion of such configured main apparatus 2. This image scanning apparatus 7 may be housed in the main apparatus or be configured as separate unit as shown in the drawing, and is configured by a platen where a document is disposed; a carriage of scanning the document on this platen; a light-receiving element of bringing the image scanned by this carriage into photoelectric conversion; and an output portion of digitalizing the image data from this light-receiving element to transfer them to the above described data storing portion 14. Moreover, an automatic document feeder (ADF unit) 5 of automatically feeding documents to the above described platen is disposed in the image scanning apparatus 7 shown in the drawing.

This automatic document feeder 5 is configured by a sheet feed tray where documents are set; separate feeding means of separating documents on this tray individually to feed them; a transport guide of transporting the documents from this separate feeding means onto the platen; and a deliver stacker housing the documents after images have been scanned on the platen. Here, such image forming apparatuses are widely used, and those with various types of structure are known. Without being limited, however, to the photocopier shown in the drawing, or electrostatic printing method in use of a laser head in particular, systems such as screen printing, inkjet printing and the like can be adopted of course. In addition, it goes without saying that the image forming apparatus is not limited to photocopiers, but may be configured as an apparatus comprising functions such as a printer, a facsimile and the like.

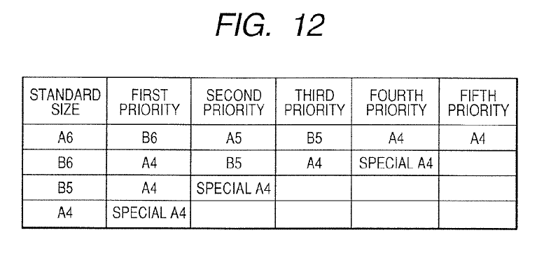

Now for explaining the configuration of the above described sheet feed portion 9, the sheet feed portion 9 is provided as described above, with a plurality of sheet feed cassettes 9a, 9b and 9c. It possibly comprises a large capacity cassette 9d which can store quantities of sheets. Normally, each sheet feed cassette comprises a sheet feed roller to separate sheets individually and feed them to a sheet feed path 10. In the sheet feed path 10, a registration roller is disposed immediately before the photosensitive drum 8. An image forming control portion CPU 201 of controlling the image forming portion 3 to be described below is provided with a print sheet select means 201a of selecting print sheets. The one shown in the drawing is configured with a control CPU 201 of the image forming apparatus A. And this control CPU 201 is connected to a RAM 201b. In this memory, a sheet size to be selected as a first priority is set from the first priority to the fifth priority for the standard size shown in FIG. 12, and at the same time, sizes of sheets stored in the sheet feed cassettes 9a to 9d are stored.

There, when the cut and bind mode is selected, the print sheet select means 201a selects a print sheet larger than this size from the RAM 201b based on the standard size (either the sheet size Gs for image data or the finish sheet size Cs) to set the sheet size Ps for a print sheet. Then, the control CPU 201 generates sheet feed instruction signal to a sheet feed cassette corresponding with this selected print sheet. In receipt of this instruction signal, the sheet feed cassette of the sheet feed portion 9 drives the sheet feed roller to send a sheet to the sheet feed path 10 and to cause it to wait at the position of the registration roller.

Concurrently, the control CPU 201 calculates a sheet periphery margin from the selected print sheet, the standard size and the bind mode (right binding or left binding) to transmit the margin information to the image forming portion 3. Calculation of this margin instructs the image forming portion 3 to take, a preset margin as the bind portion (back portion) and, as to the head portion, a margin derived by subtracting the standard size from the sheet size of the preset print sheet to divide by two, for example, as the print start position (protorusion). Then the image forming portion 3 develops the data of the data storing portion 14 based on the instructed print start position. At the time of this development, corresponding with necessity, the image data are compressed and enlarged so that the light irradiation means 13 form a latent image onto the photosensitive drum 8. Next, the control CPU 201 starts up the registration roller at the timing corresponding with an image formed in the photosensitive drum 8 to start transfer. The print sheet subject to transfer is transported from the sheet delivery path 19 through the fixing device 6 as described above.

“Configuration of Binding Apparatus”

A binding apparatus B comprises, as shown in FIG. 1 in detail, a stacking portion 42 of stacking and storing sheets in a stacked state, adhesive spreading portion 22 and cutting portion 23. The sheets subject to image forming are accepted from a sheet transport path T1 connected to deliver port of the image forming apparatus A so that the stacking portion 42 stacks to align the series of sheets in 's stacked state. And the adhesive spreading portion 22 applies adhesive to a side border of these stack sheets to be integrally bound together with the cover sheet. Thereafter the cutting portion 23 implements a series of bind processing by cutting the periphery border of this sheet stack. The apparatus shown in the drawing stacks sheets in a stacked state in a stack portion with a substantially horizontal posture, aligns the sheets in a stacked state with this posture, rotates this sheet stack S1 to implement gluing processing with a substantially vertical posture in the end border, binds it together with the cover sheet, and thereafter cuts and align the sheet periphery border with this vertical posture.

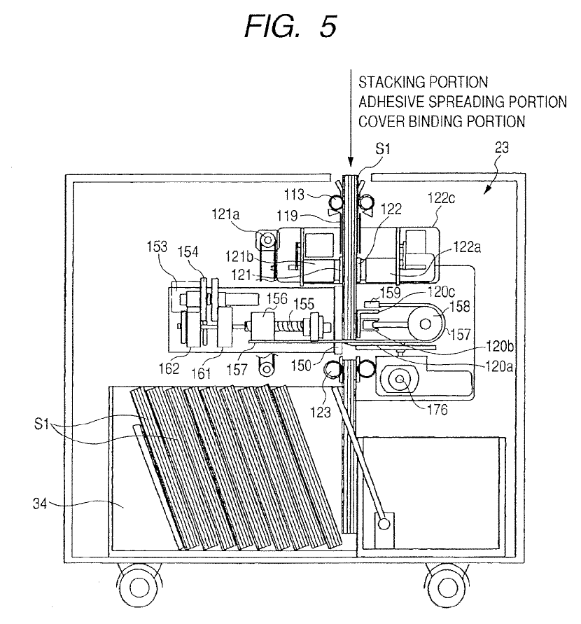

In addition, the above described sheet transport path T1 is branched in two-forked state and connected to a second transport path T2 of guiding sheets from the image forming apparatus A to the above described stack portion 42 and a third transport path T3 of guiding sheets from the image forming apparatus A to the post-processing apparatus C as shown in the drawing. Transport rollers 29 are disposed in the respective paths. Here, the binding apparatus B shown in FIG. 1 is configured to feed the cover sheet from the image forming apparatus A in appearance. The binding apparatus shown in FIG. 5, however, comprises an inserter apparatus (to be described below) of feeding the cover sheet to the sheet transport path T1 and can feed the cover sheet from this inserter apparatus. The above described sheet transport path T1 is provided with a pair of transport rollers 25 and at the downstream side of this pair of transport rollers 25, a switch flapper (switch means) 27 for switching the transport path is provided at the branch portion to the second transport path T2 and the third transport path T3.

This switch flapper (switch means) 27 is configured to be capable of selecting and carrying out a normal delivery mode of transporting the sheets from the image forming apparatus A from the sheet transport path T1 directly to the delivery tray 35 of the post-processing apparatus C via the third transport path T3; a binding mode (non-cutting mode) of transporting the sheets from the image forming apparatus A from the sheet transport path T1 to the second transport path T2, implementing adhesive applying treatment in the adhesive spreading portion 22 and binding them; and a trimming binding mode (cutting mode) of cutting border portions of a sheet stack after this binding. That is, the binding apparatus B shown in the drawing comprises a cutting mode of cutting a predetermined portions of the sheet stack S1 at a cutting stage to be described below and storing it in the storing stack portion 34 and a non-cutting mode of storing the sheet stack in the above described storing stack portion 34 without cutting the sheet stack at the above described cutting stage. Thereby, cutting/non-cutting of the sheet stack can be selected.

Respective configurations will be described below. At first, the binding apparatus B is provided with the stack portion 42 in the downstream of the above described second transport path T2. This stack portion 42 is configured by a stack tray 42a of receiving the sheets and stacks in this stack tray 42a the sheets sequentially transported from the second transport path T2 to form a series of sheet stacks S1. This series of sheets sequentially transported from the image forming apparatus A in order of page are piled on the stack tray 42a. In this case, the stack tray 42a is configured to freely move vertically in the direction of loading the sheets (the direction of thickness of the upper and lower sheet stacks S1 in FIG. 1) with vertical elevator mechanism not shown in the drawing so as to bring the tray down depending on the thickness of the sheet stacks S1. In addition, the stack tray 42a is disposed with an inclination so as to align the disposed sheets in the standard position and the one shown in the drawing strikes the sheets to a sheet end strike regulating member (not shown in the drawing) provided in the stack tray 42a in the downstream side in a delivery direction (back end of the sheets) and align them.

In addition, the delivery port 40 of the stack tray 42a is provided with a weight member 52 of pressing and guiding the top sheet to the above described regulation member so as to be freely rotatable around the rotary shaft 52a as a center. This weight member 52 retreats upward from the stack tray 42a when the sheet is transported from the second transport path T2 and presses the sheet to guide to the regulation member after the sheet is transported onto the tray. In addition, a switchback roller capable of rotating in the forward and reverse directions is disposed at this delivery port 40, transport the sheets from the delivery port 40 along the tray and rotates in the reverse direction after having transported them onto the stack tray 42a to transport the sheets toward the regulation member. Moreover, align means of aligning the width direction of the sheets are disposed in the stack tray 42a so as to align the sheet transported onto the tray in the direction perpendicular to the transport direction. For this align means, which are not shown in the drawing, a mechanism of lateral alignment by center standard and a mechanism of lateral alignment by side standard with one side border of the sheet as standard are respectively known and either of them are adoptable for the present invention.

The stack tray 42a in such a configuration moves as a whole from the position where the sheet is loaded to the first position P1 in the direction of the arrow a as shown in the arrows a and b in FIG. 1 when a series of sheet are loaded thereon. Next, the sheet stack S1 is caused to move in a direction of the arrow b perpendicular to this P1 position to be flocked out to the second position P2. The moving mechanism of this sheet, that is not shown in the drawing, moves, for example, the stack tray 42a in the arrow a direction with a shift mechanism such as rack-and-pinion and the like and moves the sheet stack on the tray in the arrow b direction with a grip transport mechanism.

And grippers 55a and 55b of retaining the end portion of the sheet stack S1 transported from the stack tray 42 are provided in the above described second position P2. This pair of grippers 55a and 55b is configured to be relatively movable between the retaining position to grip the sheet stack S1 and the release position to secede from the sheet stack S1. And the grippers 55a and 55b rotate by 90 degrees as shown with the arrow c in FIG. 1 in a state of gripping and retaining the sheet stack S1 so that the sheet stack S1 slants substantially to the vertical posture. The adhesive spreading portion 22 is provided below this sheet stack S1 retained with the vertical posture. The above described grippers 55a and 55b cause the sheet stack S1 to slant in the vertical posture and at the same time the sheet stack S1 is transported to the adhesive spreading portion 22 disposed in the lower place. These grippers 55a and 55b are designed to reciprocally move between the retaining position of retaining the sheet stack S1 in the second position P2 and the position where the sheet stack is delivered to the cutting portion 23 to be described below.

Next, the adhesive spreading portion 22 comprises an adhesive unit 66 configured by an adhesive container 66a of storing adhesive (for example, glue) and a spreading roller 66b of spreading adhesive stored in this adhesive container 66a onto end borders of the sheet stack S1. The adhesive unit 66 is retained by the grippers 55a and 55b and spreads adhesive such as glue onto the lower end border of the sheet stack S1 substantially in a vertical posture. Therefore, the adhesive container 66a shown in the drawing is movably supported by a guide rail (not shown in the drawing) in a freely movable fashion from the front side to the back side in FIG. 1, and is configured to be freely movable between the spread region of moving and gluing along the lower end border of the sheet stack S1, a position in readiness of getting prepared for spread processing outside this spread region and the refill position of undergoing refill of adhesive. That is, this adhesive unit 66 is supported freely movably along the guide rail a path longer than the sheet width size.

In addition, the above described adhesive container 66a is provided with a spread roller 66b being impregnated with an adhesive such as heat resistant rubber, and this spread roller 66b is designed to rotate with a drive motor not shown in the drawing. And at the time when the adhesive container 66a moves along the end face of the sheet stack S1, this spread roller 66b forms a small gap to an end face of the sheet stack S1 to rotate so as to implement adhesive applying treatment onto the end face of the sheet stack S1. Here, changing the gap between the spread roller 66b and the end face of the sheet stack S1 corresponding with thickness of the sheet stack so as to enable adjustment of the amount of adhesive.

Now, operation, by the adhesive spreading portion 22, of spreading adhesive to the end border of the sheet stack S1 transported by the grippers 55a and 55b in the above described configuration will be described. As described above, the sheet stack S1 sandwiched by the grippers 55a and 55b to descend undergoes positioning substantially in a vertical state at a predetermined position on the spread region on the movement path of the adhesive unit 66. Then, the adhesive unit 66 having been ready in a position of readiness moves along the lower end border of the sheet stack S1 while the spread roller 66b rotates to implement the adhesive applying treatment in the end border of the sheet stack S1. When the adhesive unit 66 reaches the end border of the sheet stack S1, the spread roller 66b rotates in the reverse direction so that the adhesive unit 66 moves from the returning position to the starting position. And at the stage where the adhesive unit 66 reaches the starting position again, the spread roller 66b stops and the adhesive unit 66 stops at the point of readiness as well.

When this adhesive unit 66 is positioned in the position of readiness, the transport path of the sheet stack S1 is secured while the sheet stack S1 having undergone an adhesive applying treatment is transported to the cover adhesive portion 60 by the grippers 55a and 55b. The cover adhesive portion (cover sheet binding portion) 60 is provided in the cross portion between the third transport path T3 and a transport path of the sheet stack S1 retained by the above described grippers 55a and 55b and transported. The cover sheet is transported to the third transport path T3 in a method to be described below and the sheet center is prepared so as to be located in the cross portion. There, the cover sheet and the sheet stack S1 fit each other so that the sheet stack S1 corresponds with and is joined to the cover sheet center (sheet center) in an inverted T-shaped state. Here, at the time of this joining, a backup plate 59 is ready for the third transport path T3.

Here, feeding of the above described cover sheet will be described. There is a case where the cover sheet is supplied from the image forming apparatus A subject to printing of a title add the like and a case where it is supplied from an inserter apparatus annexed in the sheet transport path T1. And in the case where the cover sheet is transported from the main apparatus 2 side or the inserter apparatus to the cover adhesive portion 60, the cover is transported from the sheet transport path T1 to the third transport path T3 via the switch flapper 27 and is positioned to a predetermined position of the cover adhesive portion 60 intersects the substantially vertical transport path of the sheet stack S1. And to this positioned cover, an end border of the sheet stack S1 where adhesive has been spread is pressed from the upper side in the vertical direction with the grippers 55a and 55b. And, under this state, the sheet stack S1 is moved in the vertical direction further with the grippers 55a and 55b with the cover being left to attach the end border with adhesive. And this sheet stack S1 and the cover are pushed to freely sliding backup plate 59 located in the lower side of the cover adhesive portion 60. Thereafter, the cover and the sheet stack S1 are pressed from the both sides with freely sliding back bending plate in a state of being stricken to the backup plate 59. Thereby, a crease corresponding with thickness of the sheet stack S1 is formed on the cover.

Next, after the backup plate 59 slides and moves to outside to form the transport path T4 of the sheet stack S1, the grippers 55a and 55b sandwiches the sheet stack S1 with the cover having been adhered to deliver it downward to the cutting portion 23. This cutting portion 23 is provided with a pair of transport rollers 113 as a fold roil to take over the sheet stack S1 transported from the grippers 55a and 55b to the sheet cutting unit in the downstream side. At that time, the rollers 113 folds it in the state where the cover sheet sandwiches the sheet stack S1.

“Sheet Cutting Apparatus”

Next, based on FIG. 5 to FIG. 9, the cutting portion 23 will be described. The cutting portion 23 is configured in the following structure by cutting sheet transport means, cutter means (cutter blade) 120a, cutting border press means 120b and 120c to be described later, drive means of driving these respective cutter means and sheet transport means (delivery roller) 123. A transport guide 119 of guiding the sheet stack S1 to a vertical posture is provided in the downstream side of the transport rollers 113 of folding and transporting the above described cover sheet and the sheet stack S1. A rotary table 121 and a gripper 122 of pressing the sheet stack S1 onto this rotary table 121 are disposed in the following structure in the transport path T4 configured by this transport guide 119.

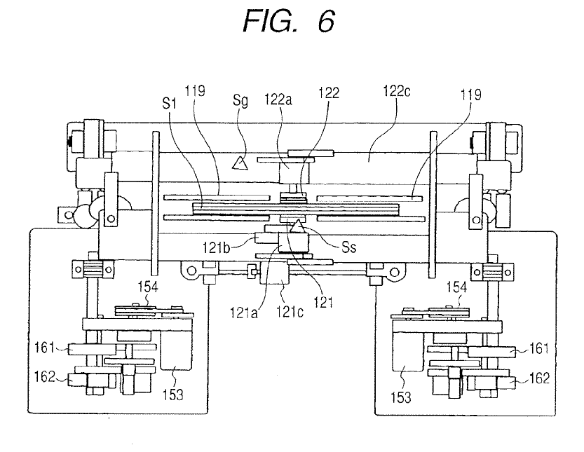

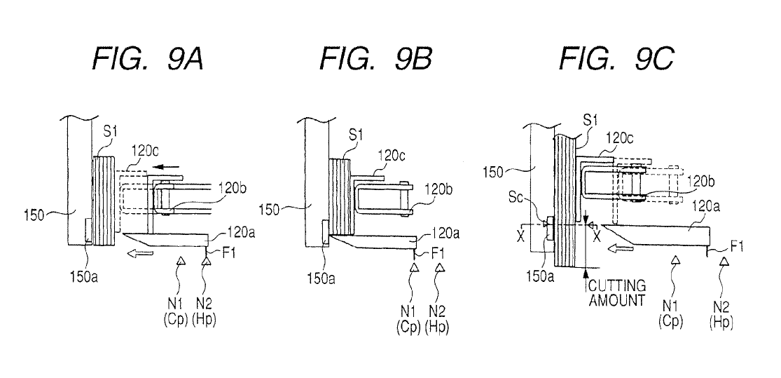

The above described rotary table 121 and gripper 122 are disposed in a unit frame 122c mounted onto an apparatus frame so as to elevate freely disposed in opposition each other to sandwich the transport guide 119. The rotary table 121 is supported by a rotary mechanism 121b provided with a rotary motor to rotate in a state of gripping the sheet stack S1 in FIG. 5. In addition, the gripper 122 is provided with a gripper moving mechanism 122a (refer to FIG. 6) comprising a grip drive motor and is configured to freely approachable to and secedable from the rotary table 121 so as to grip the sheet stack S1. This gripper 122 is mounted rotatably to the unit frame 122c so as to rotate following the rotary table 121 as well. This unit frame 122c is configured in the apparatus frame to move upward and downward in FIG. 5 in a state of gripping the sheet stack S1 with the elevator mechanism 121a. This elevator mechanism 121a supports the unit frame 122c with the guide rail of the apparatus frame so as to elevate freely and bridges a pair of pulleys disposed in opposition to the apparatus frame upward and downward with a timing belt so that the unit frame 122c is fixed onto this belt. And an elevating motor 121c is linked to one of the pulleys and the elevating motor 121c is configured by a stepping motor. Accordingly, with pulse control of the elevating motor 121c, the rotary table 121 and the gripper 122 will be transported to the cutting position X-X (see FIG. 9C) in the downstream side along the transport path T4 in a state of gripping the sheet stack S1. Accordingly, this rotary table 121 and the gripper 122 will configure the cutting sheet transport means.

The cutter means (cutter blade) 120a for cutting the sheet stack S1 and cutting border press means 120b and 120c for pressing a portion in the vicinity of the cutting border of the sheet are provided in the downstream side of the above described rotary table 121. As shown in FIG. 5 and FIG. 9, a blade receiver member 150 is disposed inside the above described transport guide 119 in a position in opposition to the cutter blade 120a of the sheet and the cutting border press means for pressing and supporting a cutting border of the sheet stack S1 shown in FIG. 5 and FIG. 9 are disposed in a position in opposition to this blade receiver means 150. These cutting border press means are configured by a holding member 120c, a movable press plate 120b and a press mechanism and the holding member 120c of applying pressure in contact to the sheet is fixed onto the movable press plate 120b. The movable press plate 120b is provided with a pair of press mechanisms left and right in the longitudinal direction.

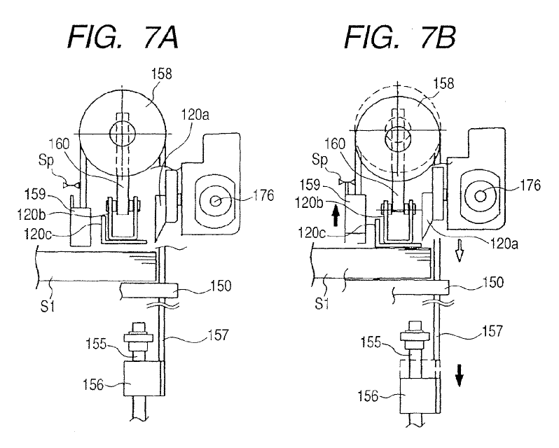

These left and right press mechanisms have the same structure and are configured by a pressing motor 153, a decelerate transmission gear 154 linked to this motor, a ball screw 155 linked to this gear, a slider 156 in engagement with this ball screw 155, a belt 157 fixed to this slider 156, a movable pulley 158 suspending this belt, and a press spring 159. The above described movable press plate 120b is linked to the movable pulley 158 through the press rod 160 and this movable pulley 158 is supported movably by the apparatus frame in the direction of an arrow in FIG. 7A to configure a normal movable pulley. And the belt 157 suspended by this movable pulley 158 is linked to the press spring 159 at one end and is fixed onto the slider 156 at the other end. Accordingly, the slider 156 is configured to move from a position in readiness apart from the sheet stack S1 to a position of pressing the sheet stack S1 when the press motor 153 is driven to rotate the ball screw 155.

In the downstream side of these cutting border press means 120b and 120c, the cutter blade 120a is supported by the apparatus frame to move the sheet stack S1 retained by the above described cutting border press means reciprocally between a position in readiness spaced apart with distance from the sheet and the cutting position (a position where sheet cut is completed). In addition, the cutter blade 120a is configured to move reciprocally from the position of readiness to the cutting position with a drive cum now shown in the drawing. And a cutter drive motor 206d is linked to this drive cum. This cutter blade 120a undergoes position detection with sensors N1 and N2 disposed in two places shown in the drawing in FIG. 9A so that the position sensor N2 detects the home position of the cutter blade 120a with its flag F1 and the position sensor N1 detects the cutting position. Here, a sensor Sc of detecting the tip of the sheet stack S1 is disposed in the cutting position (X-X shown in FIG. 9C) where this cutter blade 120a is located so as to control the elevating motor 121c of the unit frame 122c that has mounted the above described rotary table 121.

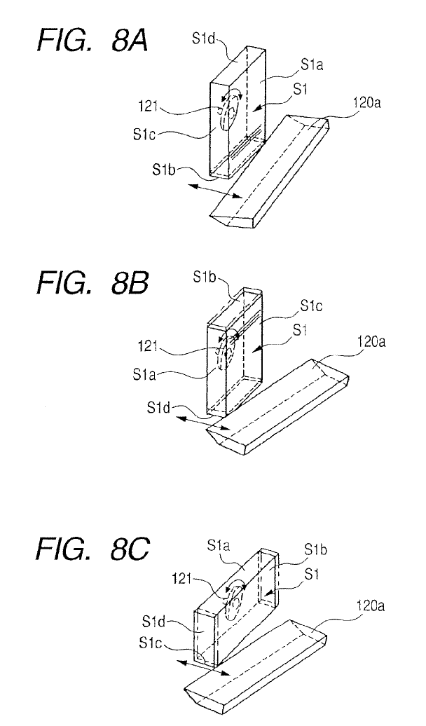

Next, a method of cutting the sheet stack S1 with the cutter blade 120a will be described based on FIG. 8A to FIG. 8C. The depicted apparatus is characterized by retaining the sheet stack S1 with the above described rotary table 121 and the gripper 122 with a vertical posture to cause the sheet stack S1 to rotate by rotary control of the rotary table 121 and sequentially cutting three places of its periphery borders. In that method, rotating head portion S1b, the tail portion S1d and the end portion S1c, which are the other end borders except this back face S1a, to the cutting potions X-X with the rotary table 121 and the gripper 122 from a state where the back face S1a as an end border with the cover being adhered is directed downward and fixing them, the cutter blade 120a cuts sequentially in this cutting position.

FIG. 8A shows the state where the sheet stack S1 has been caused to rotate and move with the rotary table 121 and the gripper 122 to a position where the head portion S1b is cut with the cutter blade 120a, FIG. 8B shows the state where the sheet stack S1 has been caused to rotate and move with the rotary table 121 and the gripper 122 to a position where the tail portion S1d is cut with the cutter blade 120a and FIG. 8C shows the state where the sheet stack S1 has been caused to rotate and move with the rotary table 121 and the gripper 122 to a position where the end portion S1c is cut with the cutter blade 120a. In any case of cutting the end borders S1b, S1d and S1c, the sheet stack S1 sandwiched by the rotary table 121 and the gripper 122 is fixed to the cutting position X-X with the above described cutting border press means 120b and 120c and the cutter blade 120a cuts the sheet in that state.

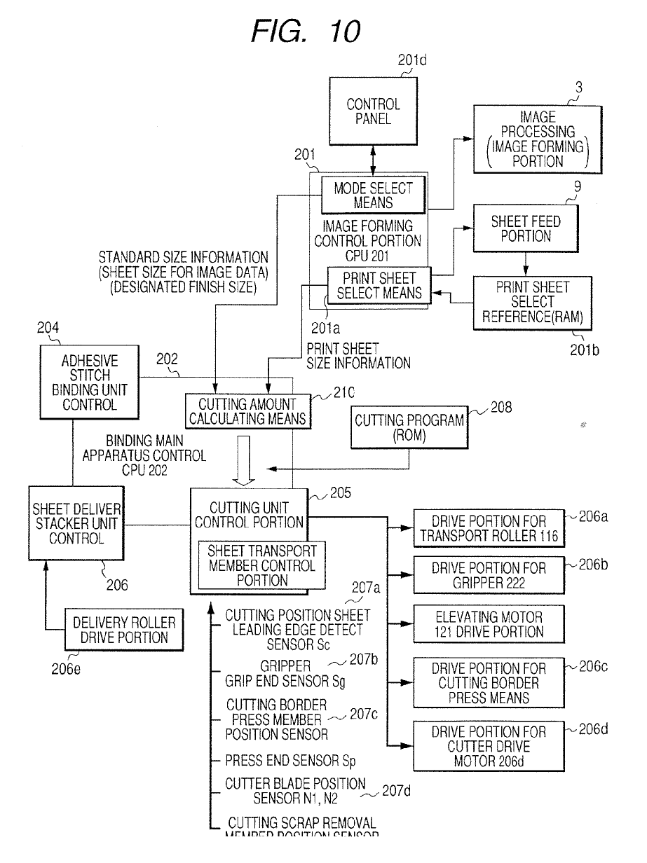

Configurations of control of the apparatuses described above will be described. FIG. 10 is a block diagram showing configurations of controlling the image forming apparatus A and the binding apparatus B. The image forming apparatus A comprises normal functions and configurations of controlling the image forming portion 3 with the control CPU 201. This control CPU 201 is provided with a control panel 201d to set the delivery mode, the binding mode and the trimming bind mode. The control CPU 202 provided in the binding apparatus B is configured by an adhesive stitch binding unit control portion 204, a cutting unit control portion 205 and a sheet deliver stacker unit control portion 206.

The cutting unit control portion 205 will be described in detail below, but respective modes will be described schematically. When the sheet delivery mode is set, the control CPU 202 operates the switch flapper 27 to transport the sheet transported from the sheet delivery port of the image forming apparatus A to the sheet delivery stacker 35 of the post-processing apparatus C via the sheet transport path T1 and the third transport path T3. At that time, the sheet does not undergo binding processing but undergoes post-processing with the post-processing apparatus C. Next, when the binding mode is selected, the control CPU 202 guides the sheet with the switch flapper 27 from the sheet transport path T1 to the second transport path T2 to place the sheet onto the stack tray 42a. Thereafter, it causes the sheet stack S1 to slant to the vertical posture with the grippers 55a and 55b and implements adhesive applying treatment onto its end border and binds it together with the cover sheet in the cover adhesive portion 60. The sheet stack S1 is made to pass through the cutting stage by the transport roller 113 and is transported to the storing stack portion 34 with the sheet delivery roller (sheet transport means) 123. Next, the cutting unit control portion 205 at the time when the trimming bind mode has been selected will be described as follows.

The control CPU 202 transmits control signals to the drive portion 206a for the transport roller 113, the drive portion for the elevating motor 121c, the drive motor 206b for the moving mechanism portion of the gripper 122, the drive motor 206c for the moving mechanism of a press member of the cutting border press means, the drive motor 206d for the cutter blade moving mechanism, and the drive motor 206e for the delivery roller 123. These control signals generate startup and stop instruction signals to the driver for the respective drive motors and otherwise generate control signals of controlling their rotation amount (movement amount). In addition, the control CPU 202 is configured to receive, in the cutting position X-X, detection signals 207a of the sensor Sc for detecting the sheet tip, detection signals 207b of the grip end sensor Sg of the gripper 122, detection signals 207c of the press end sensor Sp of the movable press plate 120b (cutting border press means) and detection signals 207d of the position sensors N1 and N2 of the cutter blade 120a. In addition, an execution program 208 of cutting operation is designed to be connected to the control CPU 202 and to configure cutting amount operate means 210 inside it.

The above described cutting amount operate means 210 is configured inside the control CPU 202 to obtain “sheet size for image data/final finish size (standard size)” information from the image forming apparatus A. At the same time, “size for print sheet” information is obtained. Based on these obtained data, the surplus margin of the sheet is calculated. This is incorporated into the cutting execution program 208 to set the “cutting and binding mode” and then length of the standard size and length of the print sheet are subtracted to calculate the surplus margin for the head portion, the tail portion and the end portion of the sheet stack S1.

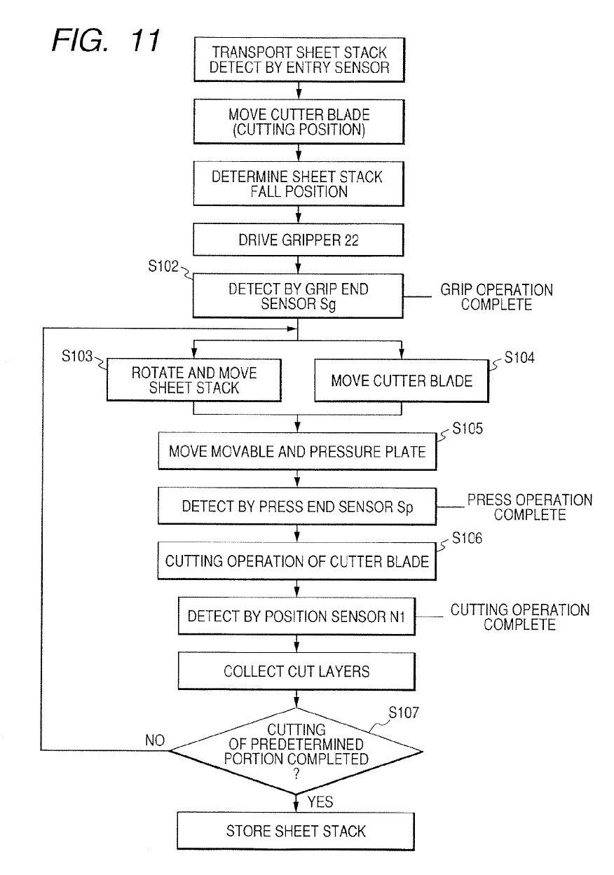

Next, control flow sown in FIG. 11 will be described. The sheet stack S1 is transported from the above described transport roller 113 then an entrance sensor (not shown in the drawing) of the transport path T4 detects this upon transport of this sheet stack and the transport roller 113 releases the sheet stack S1 which is being gripped and transported in a predetermined time after that detection signal. At that time, with the signals from the entrance sensor not shown in the drawing, the cutter blade 120a waits in the cutting position to latch the tip of the dropping sheet stack S1. Next, the control CPU 202 moves the gripper 122 from the retreat position (open position) to an operate position (grip position) so that it and the rotary table 121 nip and support the sheet stack S1. The operation of this gripper 122 is detected by the grip end sensor Sg and the signal stops the gripper moving mechanism (S102). Upon receipt, from this grip end sensor Sg, of the signal of completion of the grip operation, the rotary table 121 causes the sheet stack S1 to rotate for a predetermined rounds and to change the direction of the posture and at the same time generates a startup signal to the elevating motor 121c with the signals from the sensor Sc of the cutting position X-X.

Concurrently, the control CPU 202 counts the power supply pulse of the elevating motor 121c configured by a stepping motor so as to stop the elevating motor 121c when the pulse reaches the prior operated transport amount. With this, the sheet stack S1 is set in the cutting position X-X in a state of overrunning the cutting amount in the downstream side (S103). This overrun amount is calculated by the above described cutting amount operate means 210. In parallel along rotary movement of the above described sheet stack S1, the control CPU 202 moves the cutter blade 120a from the home position to a predetermined position of readiness (S104). At that time, the movable press plate 120b also moves in the sheet holding direction from the point of readiness. And in a predetermined time after the signal of the above described sensor Sc, the sheet stack S1, at the prospected time positioned at the cutting position X-X, the movable press plate 120b moves at first to press the sheet stack S1 onto the fixed holding plate 120c (S105). The press end sensor Sp detects completion of this press operation while the cutter blade 120a starts the cutting operation on the signal thereof (S106).

Upon completion of the cutting operation with the cutter blade 120a, the position sensor N1 detects this so as to operate the cutter blade moving mechanism adversely on the signal to bring the cutter blade 120a back to the position in readiness. There, the control CPU 202 determines whether or not a plurality of cutting processes or three cuts in the depicted case are completed (S107) and returns to the above described Step S102 in case of incompletion. In the case where all the cuts have completed, the delivery roller 123 is driven to store the sheet stack S1 in the storing stack portion 34.

Here, the present invention will not be limited to the above described embodiments but appropriate changes may be made in it without departing the gist of the present invention. For example, the image forming apparatus will not be limited to those in application of the electrophotographic process, but any type thereof including an ink jet system, a thermosensitive system and the like will do as far as images can be printed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-258369, filed Sep. 6, 2005, which is hereby incorporated by reference herein in its entirety.

What is claimed is:

1. A sheet processing apparatus comprising:
a stacking portion which loads sheets where images of image data are formed, the sheets in a standard size larger than a designated finish size on the image data;
a binding portion which binds a stacked sheet stack;
a cutting portion which cuts the bound sheet stack; and
a control portion which controls the cutting portion so that the bound sheet stack in the standard size is cut in a finish size based on finish size information of said image data.

2. The sheet processing apparatus according to claim 1, further comprising:
a sheet feed portion which retains sheets in a plurality of standard sizes;
a sheet select portion which selects sheets in a standard size larger than a sheet in said finish size from the sheet feed portion; and
an image forming portion which forms images onto a sheet in a selected standard size.

3. The sheet processing apparatus according to claim 2, wherein
said sheet select portion selects a sheet in the smallest standard size among the sheets in standard sizes larger than the finish size of said image data.

4. The sheet processing apparatus according to claim 2, wherein
said sheet select portion selects a sheet, which the sheet feed portion retains, in the smallest standard size among the sheets in standard sizes larger than the finish size of said image data.

5. The sheet processing apparatus according to claim 2, wherein
said sheet feed portion retains sheets in standardized sizes such as JIS standards A series sizes, JIS standards B series sizes, inch sizes or the like.

6. The sheet processing apparatus according to claim 1, further comprising a transport portion of transporting a sheet stack to a cutting position of said cutting portion, wherein
said control portion determines a transport amount of said transport portion according to a finish size to, thereby, control a position of the sheet stack toward said cutting position.

7. The sheet processing apparatus according to claim 6, wherein
said control portion calculates a surplus region of a sheet based on image data, a finish size of the image data and a standard size of the sheet where images are formed, determine a transport amount of said transport portion according to the calculated result and thereby control a position of a sheet stack to said cutting position.

8. A sheet processing method comprising the steps of:
loading sheets where images of image data are formed, the sheets in a standard size larger than a designated finish size on the image data;
binding a stacked sheet stack; and
cutting the bound sheet stack in a standard size in a finish size based on finish size information of said image data.

9. A sheet processing method comprising the steps of:
selecting sheets in a standard size larger than a sheet in a finish size of image data from a sheet feed portion retaining sheets in a plurality of standard sizes;
forming images onto a sheet in a selected standard size;
binding a stacked sheet stack; and
cutting the bound sheet stack in the standard size in a finish size based on finish size information of said image data.
